(19) United States
(12) Patent Application Publication
(10) Pub. No.: US 2008/0070200 A1
(43) Pub. Date: Mar. 20, 2008

(54) Textured sketch papers having grooves to help a sketcher to draw lines and figures without a guide

(76) Inventors: Daniel Louis Hachey, Bonita Springs, FL (US); Ryan Loron Johnson, Bonita Springs, FL (US)

Correspondence Address: DOONAN DWIGHT MCGRAW, 245 SAINT JAMES WAY, NAPLES, FL, 34104-6775, US

(21) Appl. No.: 11/508,767

(22) Filed: Aug. 23, 2006

(51) Int. Cl. G09B 11/00

(52) U.S. Cl. 434/85

(57) ABSTRACT

Sheets of heavy duty sketch paper are preformed with one or more grooves in them, without requiring a flat panel sheet with grooves in it, placing a paper over that flat panel sheet, and then sketching on the sketch paper with the pencil or pen following the grooves in the flat panel sheet while indenting the sheet into those grooves as is required by the prior art. The sheets of sketch paper have the grooves therein and it is the grooves of the sketch paper itself that are followed by a pencil or pen and creating lines of the sketch on the sketch paper. The sheets of heavy duty sketch paper which have preformed grooves thereon may have many very closely spaced grooves so that there is a very fine choice for using any particular groove. At other times, sheets of heavy duty sketch paper which have preformed grooves thereon may have large grooves spaced further apart so as to accommodate the use of crayons by young children and in the process of such use the young children learn more about the shapes of things and how things can be illustrated with a sense of accuracy and neatness that is not so easily done when no rulers, straight-edges or curved forms to yield better lines.

### BACKGROUND OF THE INVENTION

It has been for many years, and still is, a common practice for engineers, architects and those in many other professions to prefer to make clean straight and curve lines when they are on some sketch paper by hand, using only paper and a pencil or pen. Usually, they use a ruler or similar guide to keep their lines straight, irrespective of each line's direction. Other tools having different shapes to draw various curved sections of lines are also used. Such other tools often comprise several of them depending on the different types of curves one would like to draw, such as arcs of a circle, or curves that changed radii along the length thereof.

In 1966, a patent application was filed by Robert E. Phillips that issued as U.S. Pat. No. 3,384,964 on May 28, 1968. It tried to fill the need but was still not sufficiently simple and easy to use, because one had to place a sheet of very thin flat paper on the top surface of a flat sheet of material which was formed to contain a plurality of grooves having rounded junctures with the material 's top surface. A marking instrument was then pressed against the paper so as to depress the paper toward one of the grooves. In this location, the marking instrument was guided by the groove as it is drawn along the paper. The invention was the provision of the flat sheet made of a hard material which had a plurality of lines embossed in the top surface of the flat sheet, the lines being arranged in such directions a to be suitable for use in sketching. There were visual printed lines, that is, visual through the thin sheet of paper, on the flat hard sheet which provided a visual aid in the guidance of the sketching instrument by the embossed grooved lines in the top surface of the flat sheet which gage some measuring ability so that the lines were being sketched on the thin sheet of paper by the marking instrument as it followed the selected ones of the embossed grooves.

In the approximately forty years since that patent application was filed, the same basic construction is being offered to sketchers. It is still a three-piece construction of the flat, hard, grooved sheet, a marking instrument and a thin sheet of sketch paper, being marketed with U.S. Pat. No. 3,384,964. At times, the paper, even though it was then pushed slightly into one or more of the groove of the flat material, it might be removed and then had to be replaced on top of the grooved material to resume sketching on it. This is particularly true when the grooves are arranged in other than straight-line grids. This was, and still is, a registration problem in replacing the sketch sheet so that the indented sketch paper lines were again aligned with the grooves on the flat sheet material's top surface. Also, users have found that they usually need to fasten the sketch paper sheet to the flat sheet to be sure that it does not move while they are sketching on it. This is another obstacle to efficiency that needs to be overcome.

### BRIEF SUMMARY OF THE INVENTION

The invention is that of a sketch paper product which has a surface with a texture that enables the drawing of clean linear or curved lines without the use of a ruler or other guiding device. The paper is not thin like tracing paper, for example. It has more body to it, and is preferably made of material similar to that from which office folders are made, That material is relatively hard, and also is thicker than tracing paper or typical paper that is used for printing in a laser or inkjet printer or a typewriter, commonly known as 20 lb. paper. It may be as thick as four to twenty or thirty or more sheets of 20 lb. paper. It can even be similar to the light cardboard from which containers are made for shipping various small items. As a minimum, it must be thick enough to have grooves formed therein as later described, and when desired can be considerably thicker than that. At the same time, it must be sufficiently flexible to permit the pencil or pen point to go to the bottom of any one groove. It can also be constructed as a children's learning device by providing large grooves into which the point of a crayon may fit, so that a child can learn to draw square, triangular and rectangular boxes and connect them with lines limited only by the child's, and the child's parent or other helper, to improve the child's dexterity, visual concepts and how to draw those concepts.

Therefore, for the purpose of simplicity, it will be referred to as heavy duty sketch paper. In effect, the heavy duty sketch paper and the flat, embossed with lines, sheet of the Phillips patent are now a single product. No longer will anyone using the invention herein disclosed and claimed have to have the very hard, grooved, flat sheet required by Phillips. The grooved surface of the heavy duty sketch paper is not a guide for other sketch sheets, but is itself the sketch sheet. It is disposable or recyclable just as any other paper product. It is readily provided as individual sheets in a package, or in pad form, in all sizes and colors. Its size is not limited by the size of the flat embossed sheet of the Phillips patent. Because the heavy duty sketch paper is embossed at times with very fine, closely arranged grooves, it must be of a fine quality, and not a coarse paper such as heavy wrapping paper which usually has larger filaments of paper pulp and/or plastic filaments which would not permit very fine grooves without having some slightly ragged edges of the drawn lines due to the presence of such large filaments. By using a fine pencil or pen point, the sketched lines will have their ink at the bottom of the grooves in the heavy duty sketch paper, and will then leave only a single line when the pencil or pen point draws a line in the heavy duty sketch paper grooves. Also, the drawing of a single line is abetted by the fact that the paper is still sufficiently flexible to permit the pencil or pen point to go to the bottom of any one groove even if the pencil or pen point has to slightly spread out the groove sides. That cannot be done with the Phillips invention.

Should one think that one could simply use sheets of the flat sheet, grooved material that is disclosed by Phillips, it must be realized that his flat sheet has to be sufficiently hard to withstand at least hundreds if not thousands of lines being drawn with most of the grooves. In order to last for more than one sketch of one line, that hardness must be much greater than the hardness of the single embossed heavy duty sketch paper sheet of the invention. While at one point, Phillips states, “While a number of materials are suitable for use in the sketching device of the invention, transparent polymer composition material is preferred as the sheet material 18. Furthermore, a thermoplastic polymer composition material is preferred to aid in the manufacturing of the sketching device. However, other materials, such as paper materials or metal, can be used if desired.” Even if paper material were to be used, it would have to be very hard to last any length of time at all, and therefore would be too hard to draw only a single line. One can draw a single line when the drawing tool such as a pencil or a pen is used on the heavy duty paper sheet of the invention, because, relative to the flat sheet material of Phillips, it is soft and yielding to the pencil or pen point sufficiently to allow only one line to be drawn instead of the resulting two lines if one were to draw on the Phillips flat sheet of such hard material.

### BRIEF DESCRIPTION OF THE SEVERAL VIEWS OF THE DRAWING

FIG. 1 is a front elevation view of a first embodiment of the invention.

FIG. 2 is a front elevation view of a second embodiment of the invention.

FIG. 3 is a front elevation view of a third embodiment of the invention.

FIG. 4 is a front elevation view of a fourth embodiment of the invention.

FIG. 5 is an enlarged transverse section through one version of the embossed sketch paper of the invention.

FIG. 6 is an enlarged transverse section through the embossed sketch paper of another version of the invention.

FIG. 7 is a perspective view of a small portion of a heavy duty sketch paper which is made for children to use, with a crayon being the writing instrument.

### DETAILED DESCRIPTION OF THE INVENTION

The heavy duty sketch paper of the invention consists of a sheet of paper that has been embossed to form grooves so that either one side thereof is to have lines and such sketched thereon and is embossed with grooves, or it may be so embossed that there are embossed grooves on both sides of each sheet of the heavy duty sketch paper. Since it is a sheet which has the same thickness throughout it, in the second of those two forms, the embossed grooves appear on the other side of the heavy duty sketch sheet as embossed raised bumps and the raised bumps on the one side appear on the other side as grooves. Because, in one such form, this embossing is usually done using very fine embossing rollers that allow the heavy duty sketch paper to maintain its basic shape of the embossed lines throughout the embossed area as well as on the opposite side thereof, either side of that paper can be used for sketching thereon. That is shown in FIG. 5, and described below in greater detail. In another such form, the heavy duty sketch paper is tightly squeezed at the bottom of each groove during the embossing process, so that the paper has essentially the same thickness at the upper surfaces between the grooves, but is thinner because it is more compacted, at the sides and bottoms of the grooves. This will provide a heavy duty sketch paper that is designed to be sketched on only on the grooved side. That is shown in FIG. 6 and is described below in greater detail. Heavy duty sketch paper embodying the invention can be put together in reams or smaller packets, or can be made into pads from which the sheets of the paper can be removed one at a time if desired. This can be done in the same manners that pads of legal or standard size paper is currently made and sold. Some are attached at the upper margin and provided with a perforated line that allows the sheets to be torn off one or a few at a time without damaging the sheets themselves. Others use a version of perfect binding, where the edge surfaces of each sheets upper ends are removably glued to a back binding, and the entire sheet may be pulled away from that binding in preparation for individual use of the sheets.

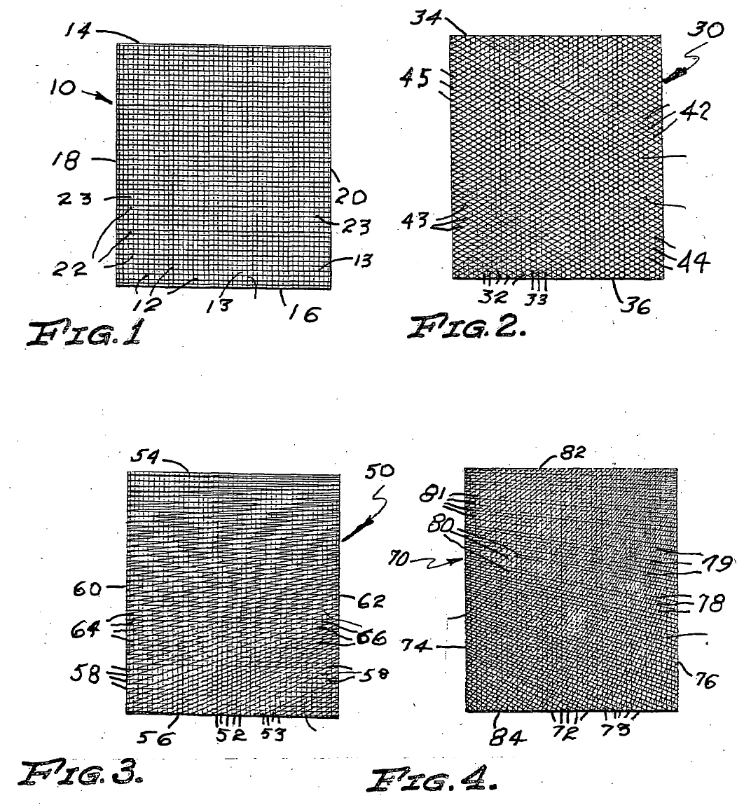

In FIG. 1, the sheet 10, which is the type of the heavy duty sketch paper earlier described, is formed with a grid of grooves 12 running from the top margin 14 to the bottom margin 16 and being parallel to the left margin 18 and the right margin 20, and grooves 22 running from the left margin 18 to the right margin 20. In this manner, the grooves 12 and 22 are similar to the lines on typical graph paper. Grooves 12 are separated by ridges 13, and grooves 22 are separated by ridges 23. In this Figure, as well as in the other FIGS. 2, 3 and 4, the grooves are shown in a magnified view, in that there are usually many more grooves than actually shown in those Figures. However, that is not always the case. There are many instances where it would be desirable to have a lesser number of grooves.

One such an instance is when the heavy duty sketch paper has been prepared for children who are starting to learn to sketch. As earlier noted, the grooves could be tailored to a child's usage and motor capabilities, and to the use of larger writing tools that are normally found in the country where the child is located. In general, children's crayons, and to some extent, children's colored pencils fall into this category. The country normally would also likely have some kind of rating as to the age group for which any item particularly made for children being brought forth, and that could extend to items that can lead to improvements to the reading and drawing capability of almost any child.

In FIGS. 1 through 4 the number of lead grooves per inch may be up to as many as 30 to 40 or 50 grooves per inch. Thus, papers with different numbers of grooves per inch can be used depending upon the accuracy that the sketcher desires in a particular sketch. Since the papers can be supplied as individual sheets or as pads of sheets, they can be packaged in different categories for ready use. Each package or pad may contain only one particular number of grooves per inch, or there may be, for example, 100 sheets in a package with 25 of them being each of four different number of grooves per inch. That is a marketing area, and not a part of the invention of having the grooves formed on the sketch paper itself, thus eliminating the need for the very hard grooved sheet that is used with sketch paper to make the lines thereon by pressing a thin sheet of sketch paper into selected grooves with a drawing tool such as a pen with a ball point.

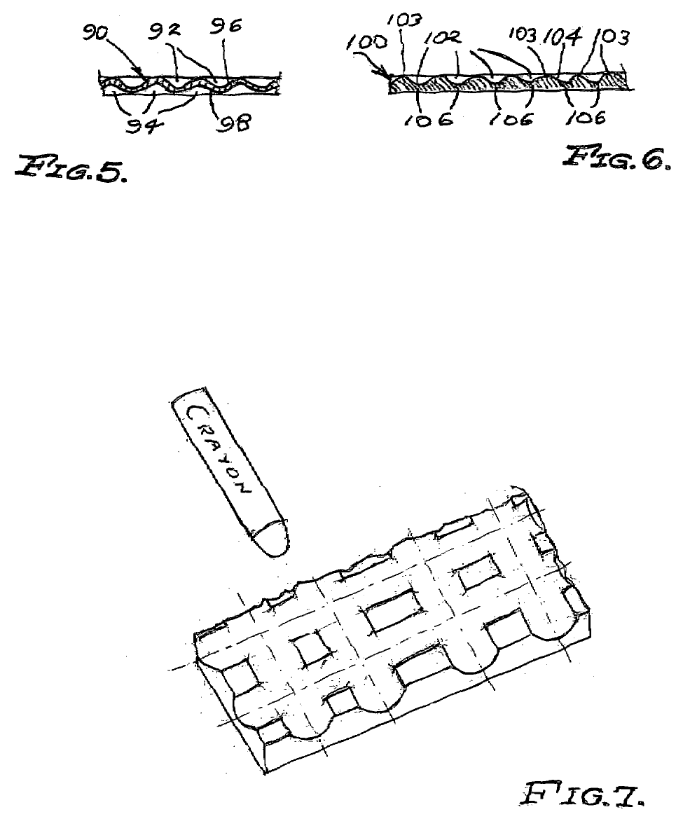

FIG. 2 presents a heavy duty sketch paper sheet 30 with one set of grooves 32 extending from the sheet upper margin 34 to the sheet lower margin 36 in lines parallel to the left margin 38 and the right margin 40, a second set of grooves 42 extending from the left margin 38 upwardly at a degree angle, which can be anywhere within an angle range of about 20 degrees to 70 degrees, and are shown in this instance as so extending at an angle of 35 degrees 16 minutes to the right margin 40, and a third set of grooves 44 extending from the left margin downwardly at a degree angle, which can be anywhere within an angle range of about 20 degrees to 70 degrees, and are shown in this instance as so extending at an angle of 35 degrees 16 minutes to the right margin 40 to the right margin 40. Thus, grooves 32 are at a degree angle to both sets of grooves 42 and 44, and the grooves 32 and 44 are also at an angle to each other. Grooves 32 are separated by ridges 33, grooves 42 are separated by ridges 43, and grooves 44 are separated by ridges 45. When paper 30 grooves 42 and 44 are arranged at the isometric angle of 35 degrees 16 minutes with respect to the upright grooves 32, they provide for an accurate representation of the illustrative cube, for the upright and angular top and bottom edges of the cube are all of equal dimension. The sketcher can then scale the isometric view for true dimensions, while perspective representations can be sketched using the heavy duty sketch paper of FIGS. 3 and 4.

FIG. 3 presents a heavy duty sketch paper or sheet 50 with upright grooves 52 extending from the top margin 54 to the bottom margin 56 of sheet 50, transverse grooves 58 extending from the left margin 60 to the right margin 62 of sheet 50, and angular grooves 64 which are all directed toward a common disappearing point to the right of the top margin 54. Grooves 52 are separated by ridges 53, and grooves 64 are separated by ridges 66. Partial perspectives can be drawn with this arrangement of grooves. In drawing a cube, for example, the square face of the cube closest to the sketcher will be shown as a square. Three of the cube edges will extend toward the disappearing point and the rear top edge and the rear right edge would also be shown. This simplified perspective can be used for quick and convenient three dimensional presentations.

FIG. 4 is also useful in sketching perspectives. This heavy duty sketch paper sheet 70 has vertically extending grooves 72 which are parallel to its left margin 74 and its right margin 76, angular grooves 78 and 80 some of which extend from one of the margins 74 and 76 and toward the extended line of the other of the margins. Most of them extend from one of the margins 74 and 76 to the other, but some extend to, and some also from one of the margins 74 and 76 or upper margin 82 or lower margin 84, disappearing points that are above the upper margin 82 or below the lower margin 84 and also beyond the extended lines of one or the other of the left and right margins. Grooves 72 are separated by ridges 73. Likewise, grooves 78 and 80 are respectively separated by ridges 79 and 81. This arrangement of the grooves is helpful when drawing a cube. The upright lines are drawn by guidance of the grooves 72, the left and right horizontal corners of the cube are drawn by guidance of the grooves 78 and the front and back horizontal edges of the cube are drawn by guidance of the grooves 80.

FIG. 5 is a cross-section representation of heavy duty sketch paper sheet 90 which may be any of the sheets 10, 30, 50 and 70, illustrating the grooves 92 and 94, which may be like any of the grooves of any of those sheets. It is provided only to illustrate one of the variations of forming grooves on a sheet of paper, in accordance with the invention. When the grooves of sheet 90 are formed by dies, which may be flat sheet dies or roller type dies, the sheet is formed with grooves 92 on one side 96 of the sheet, and grooves 94 on the other side 98 of the sheet. In this manner, one effectively has a reverse image of the side 96 formed on the side 98. Grooves 92 and 94 are respectively separated from each other by ridges 93 and 95. The advantage of this is that either side of the sheet may be used for sketching. Furthermore, in some instances, for example when using sheets with grooves like those shown in FIGS. 3 and 4 in particular, it may be beneficial to have the reverse-image capability to show three-dimensional objects.

FIG. 6 is a cross-section representation of heavy duty sketch sheet 100 which may be any of the sheets 10, 30, 50 and 70, illustrating the grooves 102, which may be like any of the grooves of any of those sheets. It is provided only to illustrate another of the variations of forming grooves on a sheet of paper, in accordance with the invention. When grooves 102 of the sheet 100 are formed by dies, which may be flat sheet dies or roller type dies, those grooves are formed on only one side 104 of the sheet, and the other side 106 of the sheet 100 remains flat. The dies that form the grooves on the sheet side 104 simply compress the paper of the sheet at and near the bottom of each groove as shown at 106. This effectively provides ridges 103 that separate grooves 102. This provides a slightly thicker sketch sheet in order to have the grooves 102 be sufficiently deep to be able guide the drawing tool within the grooves and have a single line drawn.

The groove pattern of any of the patterns shown in FIGS. 1 through 4, as well as other groove patterns, can be used in practicing the invention in some other ways. For example, as illustrated in FIG. 7, it can also be constructed as a children's learning device by providing a somewhat thicker heavy duty paper sheet 200 which has large grooves 202 and 204 into which the point of a crayon 206 may fit, so that a child can learn to draw square, triangular and rectangular boxes and connect them with lines limited only by the child's, and the child's parent or other helper, to improve the child's dexterity, visual concepts and how to draw those concepts. The grooves 202 and 204 would not only be wider, but would also be deep enough to receive the end of the crayon, and the sides 208 and 210 of the grooves 202 and 204 have a more open V shape so that the tip 212 of the crayon 206 that may have been required to have been sharpened after it has become somewhat worn would still reach the bottom of the groove. A child would learn not only to place the crayon tip 212 in the grooves 202 and 204, but would learn motor control skills such as exerting just enough pressure for the crayon 212 to color the bottom parts 214 and 216 of the grooves but would not be broken or cause significant collapse of the groove sides 208. By following the grooves with crayons, the child will learn how different shapes that can be made for coloring certain parts of certain grooves can be done. The heavy duty paper that can be used by the child will depend somewhat on the motor skills that a child already has, as well as the child's skills in drawing what he or she sees. There may be parts of a drawing on a heavy duty paper, and the child may be able to see and learn which skills will benefit him or her and to learns the satisfaction in becoming able to draw quickly and easily so that the child receives pleasure and learns the word names that identify what he or she has been drawing.

From this description and the drawings, it can be readily seen that providing the heavy duty sketch sheets themselves with the grooves, which only have to have lined drawn by their guidance of a pencil or pen, can function equally well as the sheets that have to be drawn on while they are lying on a grooved flat plate or panel, and can be provided to the sketcher, ready to use, and no grooved flat plate or panel is needed as is the case with the Phillips disclosure and claimed invention. It is grooves already provided in the heavy duty sketch sheets themselves that provide guidance for the sketching tool such as a pencil or a pen. The force the sketcher exerts on the sketching tool does not have to also deform the paper into grooves where patterns of the grooves are in a separate hard panel sheet. It also has the advantage of being able to have the grooves formed on both sides of a sheet, making that sheet more useful, and also, by having one side being the reverse image of the other, as shown in FIG. 5, the sketcher can make some sketches as a mirror image of sketches on the other side of the sheet. It also provided for a stiffer sketch sheet when the sheet has grooves formed only on one side, but with the backup of a flat sheet, the sheet being strengthened by the compression of the sheet material at the area near the bottom of each of its grooves. This provides these sheets at less expense, because one does not need the plate of Phillips each time one wants to make a sketch using grooves as an assistance.

1. A sheet of sketch paper preformed with grooves on at least one side thereof, said grooves being in one or more preformed patterns and adapted to receive therein for movement therealong the writing end of a sketching instrument such as a pencil, or a pen, or a crayon, said grooves providing guidance for the sketching instrument writing end so that the engagement of the writing end of the sketching instrument with a particular one of said grooves and moving within said particular groove draws a clean and clear line on said sheet.

2. A plurality of said sheets of sketch paper defined in claim 1, said sheets of sketch paper being bundled as packets of individual sheets for distribution and sale.

3. A plurality of said sheets of sketch paper defined in claim 1, said sheets of sketch paper being made into pads of such paper and having upper sheet edges or margins typically being joining at or near the said upper sheet edges or margins.

4. The sheet of sketch paper of claim 1, wherein said sheet of sketch paper is preformed into a defined groove pattern with said grooves being formed on both sides of said sheet.

5. The sheet of sketch paper of claim 4, wherein said grooves on one side of said sheet are separated by ridges on one side of said sheet, said ridges becoming other grooves on the other side of said sheet and said other grooves are separated by other ridges that are formed by said grooves on said one side of said sheet when they are formed on said sides of said sheet.

6. The sheet of sketch paper of claim 4, wherein said grooves on one side of said sheets are identical with but mirror image of said grooves on the other side thereof, the formation of grooves on one side forming ridges on the other side of said sheets, and the ridges on the one side forming grooves on the other side of said sheets.

7. A sheet of the sketch paper of claim 1 having opposed sides, wherein only one side of said opposite sides of said sheet has preformed with using grooves and ridges on a die first part, and the other opposite side of said sheet is flat and has been supported in the preforming process by a flat die second part, the forming of portions of said sheet of sketching grooves which are the inner ends thereof resulting from having been compressed by stamping action of the die parts so that the overall thickness of each of the sheets is substantially maintained the same as before the grooves were formed.

8. The sheet of sketch paper of claim 1, wherein said sheet is a heavy duty sketch paper having a thickness which is the equivalent to the thickness of at least four sheets of 20 lb. paper such as is used in printers and typewriters.

9. The sheet of sketch paper of claim 1, wherein said sheet is a heavy duty sketch paper having a thickness within a range which is the equivalent to the thickness of four sheets to thirty sheets of 20 lb. paper such as is used in printers and typewriters.

10. The sheet of sketch paper of claim 1, wherein said sheet is a heavy duty sketch paper having a thickness which is the equivalent to the thickness of the material of which typical manila file folders are made.

11. The sheet of sketch paper of claim 1, wherein said sheet is a heavy duty sketch paper having a thickness which is the equivalent to the thickness of hard but flexible cardboard of a type that is typically used to package small items.

12. The sheet of sketch paper of claim 1, wherein said sheet is a heavy duty sketch paper having a thickness in the range of 1 millimeter to about 10 millimeters.

13. The sheet of sketch paper of claim 1 in which said sheet also has a grid layout printed thereon after said grooves have been preformed thereon to provide accuracy of said grid layout, said printed grid layout being visible to a typical sketcher when that person is in the process of drawing on said sheet using said grooves.

14. The sheet of sketch paper of claim 1 in which said grooves on said sheet form a grid layout which is visible to a typical sketcher when that person is in the process of drawing on said sheet using said grooves.

15. The sheet of sketch paper of claim 1 in which said paper is designed to provide a sketch paper for a young child with which that child can learn how to draw various objects, develop a knowledge of three-dimensional drawings on a two-dimensional sheet, develop motor control skills, and enjoy sketching, said writing instrument being any one of a set of typical child's crayons and said grooves being of a size that accommodates the writing end of any of said child's crayon set and therefore being more widely spaced apart than when said paper is adapted to be used with a writing instrument that is a pencil or a pen.

16. The method of sketching on a sketch paper by using grooves previously formed directly on the sketch paper and a pointed-end writing tool by inserting the pointed end of the writing tool in a selected groove and engaging the end of that pointed end with the bottom of the selected groove and moving the pointed end of the writing tool a desired distance within the groove and with the guidance of the sides of the selected groove drawing a line in the groove while so moving the pointed-end writing instrument.

17. The method of sketching on sketch paper in accordance with claim 16, by providing the grooves and more specifically providing ridges that separate adjacent grooves on at least one side of the sketch paper which are extensions of the sides of adjacent grooves and which the sides of the selected groove are engaged by the pointed-end writing tool so that they provide guidance for making drawn lines and the like on the sketch paper.

18. The method of claim 16, said grooves being separated by ridges and groove sides on either side of each groove, the placement of the writing point of the writing tool being done with sufficient force to insert it sufficiently deep into the groove for the bottom of the groove to be engaged by the writing point of the writing tool so that the writing tool writes thereon with the sides of that groove providing guidance to the writing tool as it is moved along the groove with the side forces exerted on the writing tool during the writing being insufficient to permanently deform the transverse shape of the groove.
